(19) United States
(12) Patent Application Publication
(10) Pub. No.: US 2024/0384664 A1
(43) Pub. Date: Nov. 21, 2024

(54) DATA CONCENTRATION SYSTEM

(71) Applicant: MEGGITT SA, Fribourg (CH)

(72) Inventors: Dominique Vez, Cottens (CH); Pierre-Alain Brodard, Neyruz (CH); Adrien Corne, Belfaux (CH); Bertrand Pichon, Saint-Légier-La Chiésaz (CH); Christophe Blouët, Bulle (CH); Sophiane Mazouni, Lossy (CH)

(73) Assignee: MEGGITT SA, Fribourg (CH)

(21) Appl. No.: 18/787,789

(22) Filed: Jul. 29, 2024

Related U.S. Application Data
(63) Continuation of application No. PCT/IB2023/050918, filed on Feb. 2, 2023.
(60) Provisional application No. 63/306,863, filed on Feb. 4, 2022.

(51) Int. Cl. F01D 21/00; B64F 5/60

(52) U.S. Cl. CPC F01D 21/003; B64F 5/60; F05D 2260/83

(57) ABSTRACT

A distributed system for monitoring an aircraft or a gas turbine engine for an aircraft with many sense devices positioned at different locations. Data acquisition units receive an electric signal from one sense device, or a plurality of electric signals from various sense devices, convert it or them to digital sensor data. The data acquisition units have access to a digital network, which is an integral part of the distributed system of the invention and enables the transmission and distribution of the digital sensor data in this manner. The invention can use several digital networks.

### CROSS-REFERENCE TO RELATED APPLICATIONS

This continuation application claims priority to International Patent Application PCT/IB2023/050918, filed on Feb. 2, 2023, which has published as WO 2023/148654, which claims priority to U.S. Provisional Patent Application 63/306,863, filed Feb. 4, 2022, the entire contents of which are fully incorporated herein with these references.

### FIELD

The present invention generally relates to control and monitoring of gas turbine engines such as, but not exclusively, turbofan engines in aircrafts. The invention is more particularly concerned with a distributed control and monitoring architecture for said engines.

### BACKGROUND

Most modern gas turbine engines are controlled by a highly integrated and redundant electronic control, often indicated with the acronym FADEC (standing for Full Authority Digital Electronic Controls) or EEC (Electronic Engine Control), but other denominations are used. As the control of a modern gas turbine relies on a high number of parameters from several sensors placed in many engine's locations, conventional centralized control units host a large array of data interfaces capable of receiving and processing all these electric signals. The sensors must be connected individually and independently to the control unit, as well as to a power source, which leads a non-negligible weight of cables and many failure points.

Together with the capability of controlling the engines in all foreseeable conditions, modern gas turbines also are expected to provide sophisticated monitoring capabilities, where certain functional parameters are constantly analysed and logged, the aircraft systems and the crew are forewarned of abnormal conditions, and maintenance operations are scheduled accordingly. Engine control and engine monitoring are often dealt with separately, for safety reasons, and the relevant data are organised in segregated domains. Nevertheless, the limitations of centralised control systems apply to monitoring systems as well.

Distributed architectures have been proposed in alternative to the conventional centralized approach. In these, the control and/or the monitoring functions are distributed between sensors and smart data processing units that generate and react to digital messages on a suitable data network, and one or several network controllers. These architectures may reduce the length and weight of interconnection cables, but analysing their intrinsic safety is not straightforward.

Hence, there is a need for a solution to reduce the complexity of interconnecting an array of decentralised sensors, to a controller.

### Glossary/Abbreviations

This section presents a glossary of relevant abbreviations that may appear in the present disclosure. Some are of common use. Other are specific to this disclosure.
A/D Analog to Digital
AC Alternating Current
ADC Analog/Digital Converter
API Application Program Interface
AR&T Applied Research and Technology
AS Application Software
BIT Built-in Test
CAN Controlled Area Network, a vehicle bus
DAC Digital/Analog Converter
DAL Design Assurance Level
DATU Data Acquisition and Transmission Unit
DC Direct Current
DCS Data Concentration System
DCU Data Concentration Unit
DTTU Data Transformation and Transmission Unit
ECM Electronic Control Module
ECU Electronic Control Unit
EDCS Engine Data Concentration System
EDCU Engine Data Concentration Unit
EEC Electronic Engine Controller
EIS Entry in Service
EMU Engine Monitoring Unit
FADEC Full Authority Digital Engine Control
FE Front-End
FLOPS Floating Point Operations per Second (computer speed unit)
FSM Finite State Machine
HW Hardware
HM Health Monitoring
HT/HTE High Temperature Electronics
IC Integrated Circuit
LCC Life Cycle Cost
LRU Line Replaceable Unit
LVDT Linear Variable Differential Transformer, Displacement Sensor
MRL Manufacturing Readiness Level
MRO Maintenance Repair and Operation
MTX Aircraft Maintenance Operations
OEM Original Equipment Manufacturer
OMS Oil Monitoring System
OS Operating System
PE Piezo-Electric
PTP Precision Time Protocol (IEEE 1588)
RTC Rear Time Clock
RUL Remaining Useful Life
SCAU Signal Conditioning and Acquisition Unit
SPI Serial Peripheral Interface, a synchronous serial interface
SW Software
TDR Time-Domain Reflectometry
TRL Technology Readiness Level

### SUMMARY OF THE EMBODIMENTS

An aim of the present invention is the provision of a distributed system for monitoring an aircraft or a gas turbine engine for an aircraft with enough sense devices positioned at different locations on the aircraft or on the gas turbine engine. The sense devices may include, just to cite some examples, temperature sensors, pressure sensors, tachometers, vibration sensors, linear or angular displacement sensor, accelerometers, fluid level sensors, oil quality sensors, power sensors, airspeed sensors or, in general any sensor capable of transforming a physical parameter of the aircraft or of the gas turbine engine into a suitable analog signal representing said physical parameter.

Remarkably, the distributed system of the invention has data acquisition units that receive an electric signal from one sense device, or a plurality of electric signals from various sense devices, converting it or them to digital sensor data. The data acquisition units have access to a digital network, which is an integral part of the distributed system of the invention and enables the transmission and distribution of the digital sensor data in this manner. The invention can use several digital networks. CAN bus is a possible choice, but not the only one.

This arrangement brings several important advantages. One of them is that the data acquisition units can be placed strategically in the engine or in the aircraft to be as close as possible to the sensing devices that they are connected to. In this manner, the length of the cable connections and the weight of the whole system are reduced.

Another remarkable advantage is that the digital network is inherently a scalable and expandable medium of communication to which more nodes and data acquisition units can be added without excessive burden. The designer can then upgrade the sensors' configuration, replace a sensor with another of different performances, without redesigning the whole system. The destination of the data from the data acquisition unit can be reconfigured to generate new data analyses. Furthermore, the invention enables quicker and cheaper upgrades of the engine monitoring solution reducing the need for re-certifying a complete system.

Dependent claims relate to optional features of the invention that, without being essential, provide special solutions and additional advantages. Among these is the real-time correlation of information coming from diverse sensors. Preferably, data acquisition unit have each a clock, and the system includes a network mechanism to align the clocks, whereby the measures of all the physical parameters in the system can referenced to a common time system within a guaranteed time uncertainty. Multiple readings can be linked together or correlated in time thanks to this feature, providing a better understanding of anomalies such as surges, foreign object damages, engine flameouts, blade failures, take off, and so on.

Preferably, the time uncertainty of the inventive system is 100 ms or better. This resolution is adequate for understanding and detecting various transient events that may be relevant to engine monitoring and control. In some use cases, such as for example the time-correlated analysis of vibrations of engine rotors, a finer resolution is beneficial. The target time uncertainty in such applications is preferably 140 μs, more preferably 35 μs (corresponding to ±10°, respectively ±2.5° at 400 Hz). Embodiments of the invention can attain and surpass these values.

Data acquisition units can communicate directly on the digital network, by means of a suitable data interface, or else access the network through a separate module, to which they are connected point-to-point, for example by a serial link. The distributed system of the invention may include data concentration modules that receive digital data from multiple data acquisition units in this manner and relay them on the network. Data concentration modules can be a separate unit with a network interface or be part of a data acquisition unit which is itself a network node and can also serve other data acquisition units that are connected by serial links. The data concentration modules can have a role of master of the data links. The invention may make use of any suitable serial communication protocol, SPI being a possible, but not exclusive, solution.

The system of the invention can include also signal conditioning units that have a serial communication interface that receive sensor data from one or more data acquisition units and retransmits them on the network, possibly after some operation on the data themselves, like a unit conversion or a calibration.

Data acquisition units may include an ADC to transform an amplitude analog signal into a digital one. Advantageously, the ADC can have several input channels and digitise signal coming from different sense devices connected to one data acquisition unit. This multiple conversion may be done through a time multiplexer.

Another advantageous optional aspect of the invention is the provision of a DC power distribution bus to supply the data acquisition and distribution units. This DC bus may be powered by a centralised AC/DC converter that receives AC power from the engine alternators, and/or by backup batteries. The DC bus may be physically distinct from the digital data network, or the DC power can be distributed over the data bus, using the same conductors that are used to transmit data.

Yet another advantage of some variants of the invention is that the data acquisition units may be designed to withstand high operating temperatures and tested for reliable operation at high temperature according to aeronautic standards. In this disclosure “high temperature” designates environmental temperatures that are considerably above those of standard electronics, but are often found in jet engines, for example an environmental temperature above 100° C. or above 120° C. Thanks to this capability, these variants of the invention can be placed even closer to critical sensing units, for example temperature and pressure sensors monitoring the conditions of the combustion chamber.

The invention is not limited to analog signals constituted by a voltage or current amplitude, but may also treat optical signals, or impulsive signals where the relevant information modulates a train of pulses, among others.

In the network, sensor data are preferably organised in segregated domains and may comprise data belonging to an engine control as well as data belonging to an engine monitoring. Preferably the network has an inherent safety mechanism that guarantees the delivery of engine control data above engine monitoring ones. The segregation may be at the physical level, or at the logical level.

There are special data processing modes that can be used in the frame of the present invention. For example, the data from a tachometer, measuring a shaft rotation speed can be correlated with those of a vibration sensor reading the vibrations issued from the shaft. The data acquisition unit could extract an auxiliary speed value, by a suitable spectral analysis of the vibration data, in addition to the speed available through the tachometer. The auxiliary speed can be used as additional information or as a backup should the tachometer signal become unavailable.

The system may interface with an engine controller unit, for example a FADEC unit that receives the data needed for controlling the engine through the digital network.

The invention is also embodied by a method of monitoring an aircraft or a gas turbine engine comprising: positioning a plurality of sense devices at different locations on the aircraft or on the gas turbine engine, positioning on the aircraft or gas turbine engine data acquisition units configured to receive analog signals from at least one sense device and convert it to digital sensor data, wherein the data acquisition units have access to a digital network, transmitting an analog signal representing a physical parameter of the aircraft or of the gas turbine engine from a sense device to a data acquisition unit, converting the analog signal to digital sensor data in the data acquisition unit that receives the analog signal, and transmitting the digital sensor data on the digital network.

The method the invention may also foresee optional features like the transmission of digital sensor data by more than one data acquisition unit to a data concentration module, wherein the data concentration module might be part of a data acquisition unit or a separate node in the digital network, transmitting the digital sensor data to the data concentration unit on a serial point-to-point link, synchronising a clock of a first data acquisition unit with a clock of a second data acquisition units, computing an auxiliary speed value from digital vibration data captured by a vibration sensor on a rotating shaft, correlating digital vibration data of a shaft with digital rotation data of the same shaft in a digital processing resource on the digital network.

The present document describes a distributed solution for monitoring an aircraft. This distributed system may include a data concentration system later referred as DCS. Advanced data analytics are increasingly being used by Aerospace OEMs to improve engine and aircraft effectiveness and efficiency, as well as to reduce total cost of ownership. Increasing volume is, therefore, being placed on the data produced by the suite of sensors on an aircraft or on engine. Benefits brought by enhanced distributed solution mostly aim at increasing the engine/aircraft competitiveness:
Sensing accuracy, data availability enables on engine/aircraft performance increase, which in turns reduces fuel consumption and emissions.
Creates a need for highly modular and configurable distributed modules performing sensor data processing upstream data end-users.

The distributed system concept presented in this document focuses on aerospace data transformation chain, starting from the sensors output to the delivery of reliable, powerful and timely data and information to the engine/aircraft control loop and to the engine/aircraft condition and trend monitoring block. The concept is aimed to be integrated into the new generation of aircraft engines and airframes (fixed and rotary wing) and to bring innovation to the current control and HM domain, which are completely segregated from each other.

In contrast with the invention, in current existing engine architectures the control is handled by the FADEC with its dedicated sensors directly connected with it, independently of the sensor location which may be at the very opposite end of the engine, the HM is handled to the EMU with its dedicated sensors directly connected with it. Some data from control sensor is also relayed to the EMU by the FADEC. The HM processing results are sent to aircraft systems. Remaining maintenance data is stored and may be transferred to a wired ground station when the engine/the aircraft is under maintenance.

The following list underlines the differences between the present solution and the classical architecture and outlines an innovative concept of Data Concentration System summarised below:
The DCS is a central data hub. It acquires, processes and outputs healthy-ready, high added value data to engine, aircraft and ground-based health systems leading to the following benefits:
   Enhanced sensing data package (quality, reliability, consistency, format)
   Weight reduction by reducing both cabling and electronics footprint
Several architectures are proposed to tailor a wide variety of customer needs.
A system variant leading to high benefits features a distributed architecture with highly miniaturised data acquisition units (DATUs, SCAUs) placed next to each engine/aircraft sensor and sending smart sensing data via a centralised network bus to the main data Concentration Unit (DCU, EDCU) which then performs advanced processing and interacts with external end-systems.
The system provides maximum modularity to handle both safety critical control and health monitoring in a common framework.
The saving in weight and complexity can be further improving by tailoring the architecture of the distributed system's variants.
The system of the invention proposes standard functional modules that include a provisional platform for customer's application software.

### BRIEF DESCRIPTION OF THE DRAWINGS

Exemplar embodiments of the invention are disclosed in the description and illustrated by the drawings in which:

FIG. 1 illustrates schematically an implementation of the engine data flow in a known baseline architecture.

FIG. 2 represents engine data flow in an embodiment of the invention.

FIG. 3 shows, in a graph, the role of the distributed system of the invention.

FIG. 4 illustrates schematically an embodiment of the invention with a star topology.

FIG. 5 shows the functional allocation of resources in the embodiments of FIG. 4.

FIGS. 6 and 7 show schematically another embodiment of the invention with a distributed network and illustrate its functional allocation.

FIGS. 8 and 9 show schematically yet another embodiment of the invention with a tree topology and illustrate its functional allocation.

FIGS. 10 and 11 illustrate the functional allocation of an embodiment of the invention including optical sensor and relation to a possible topology for the same.

FIGS. 12 and 13 show use cases of the invention.

In the figures, remarkable elements are identified by reference signs that are repeated in the text. The same reference sign may be used to identify distinct elements that are identical, similar or technically equivalent. When many identical, similar or equivalent elements are present, some reference signs may have been omitted to avoid overcrowding the figures.

### DETAILED DESCRIPTION OF EMBODIMENTS OF THE INVENTION

The distributed architecture may deal with data collected by sensors in an engine of an aircraft as well as in the airframe. Such data may belong to diverse design assurance levels. Notably, the system may deal with data relating to real-time engine control (typically DAL A or B, control domain, safety-critical) and data relating to health monitoring of airframe/engine (typically DAL C, D or E, health monitoring domain, safety-concerned). The rationale of this choice is that including all sensing domains in the system simplifies considerably the sensing architecture. This is not an essential feature of the invention, however. Embodiments of the invention may deal with data belonging in one single safety domain. Such a restriction may be justified by safety and regulatory considerations, for example.

The DCS of the invention enables advanced algorithms targeting prognostic, high added-value trend monitoring and smart maintenance programming, that may be AI-based and are not performed directly on the engine. Useful input data for such services may be transmitted to ground data centres by a wireless link between the aircraft and a ground receiver, or by any other suitable transmission mechanism. The link could be an airframe-satellite link transmitting live information from the aircraft in flight or a ground Wi-Fi dumping past flight data. Current and projected engine/airframe compatible electronics are not expected to accommodate multi-core giga-FLOPS performance processors required by advanced MTX algorithms. Ground-based computing systems, on the other hand, provide these performances cheaply. The system of the invention provides contextualized data to ground-based powerful computing system where the advanced processing takes place.

The following examples refer to engine applications for concision's sake, although the invention is not limited thereto. The examples can be transposed to other applications, for example a distributed system that monitors sensors in the whole span of an aircraft, or system that collect data from both engine-mounted sensors and airframe-mounted sensors. Four engine locations are typically referred to:
FL1: fan location 1—on the fan case;
also features all current electronic boxes and future DCU.
FL2: fan location 2—around the compressor intermediate case.
CL1: core location 1—around the combustion chamber.
CL2: core location 2—around the turbine intermediate case.

The below table summarises typical sensor locations, types and functions. Sensors used in the control domain are shown in bold characters and those relating to the HM domain in italic; However, from a strictly procedural standpoint, both datasets are relevant to HM.

TABLE 1
locations

| platform | FL1 | FL2 | CL1 | CL2 |
|---|---|---|---|---|
| Pressure | 1 | 1 | 2 + 1 HM | 1 |
| Temperature | 1 | 1 | 1 | 1 + 1 HM |
| Speed | 1 | 2 | | |
| Vibration | 1 | | 1 | 1 |
| Other | | OMS | | |

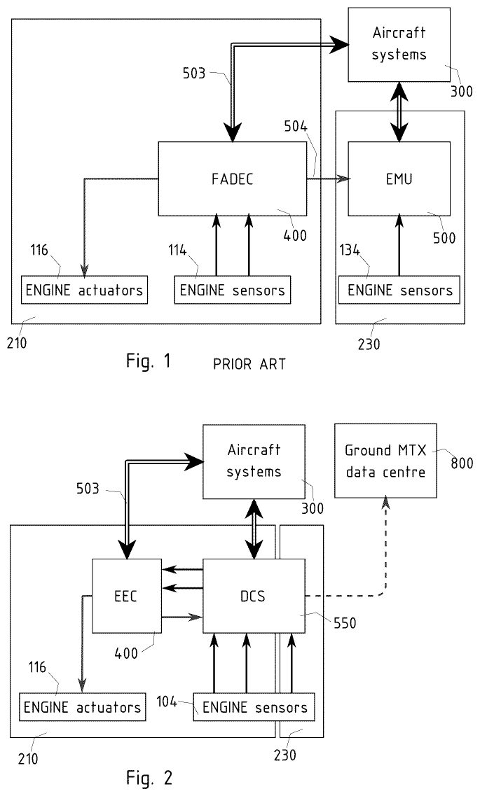

FIG. 1 shows engine data flow in a known legacy baseline system where data belonging to control domain 210 are completely segregate from those of HM domain 230, issue form dedicated sensors and travel on separate physical media.

The control is handled by the FADEC 400 with its dedicated sensors 114 directly connected to it, independent of the sensor location which may be at the very opposite end of the engine. The control loop output is fed back to actuators 116 from the FADEC. Finally, a digital interface 503 between the FADEC and aircraft systems allows the transfer of setpoints and engine indications.

The HM is handled by the EMU 500 with its dedicated sensors 134 directly connected thereto. Some data from engine control is also relayed to the EMU by the FADEC (arrow 504). The HM processing results are sent to aircraft systems 300. Remaining maintenance data is stored and may only be transferred to a wired ground station when the engine undergoes maintenance.

The baseline systems of FIG. 1 have proven their worth in decades of flight use. It has a clear segregation at the physical level between the control domains and the monitoring domain and is easier to certify at LRU-level. The different LRUs are also clearly separated. Nevertheless, the architecture is not weight optimised. LRUS are heavy fan-mounted units. The point-to-point cabling leads to high heavy duty cabling length and weight figures. Finally, the architecture is rigid, and adding sensors is not straightforward, and makes for tedious recertification during product life.

FIG. 2 represents engine data flow in an embodiment of the invention with a data concentration system whose goals are to acquire, transform and transmit data from the sensors. The invention provides ready-to-use contextualised control data to the EEC/FADEC to insure safe and optimal engine operations, HM data to aircraft systems to warn the cockpit of potential malfunctions and hazards in the engine, HM data to MTX stakeholders allowing reliable prognostics and leading to reduced LCC.

The DCS 550 plays a central role in implementing the above mission statement and serves as engine data hub. The DCS 550 receives data from a set 104 of engine sensors. Airframe sensors may be added without leaving the inventive scope, although FIG. 2 shows a realization in which the data transiting through the DCS 550 relate to engine only. The sensors 104 may belong to control domain 210 and to monitoring domain 230 and transmits them to EEC 400 through a suitable digital data network. Although the figure represents the DCS as a functional block, this does not imply a monolithic device. On the contrary, as it will be disclosed further, the DCS may include a plurality of network-capable units distributed in the engine and/or in the airframe.

The EEC 400 receives the relevant data from the DCS 550 and controls the engine, as in the baseline system of FIG. 1 in this embodiment. The system also dispatches HM relevant data to aircraft system 300 and includes a wireless data interface—such as Wi-Fi, for example—to transmit HM data to a ground MTX data centre 800 for further processing.

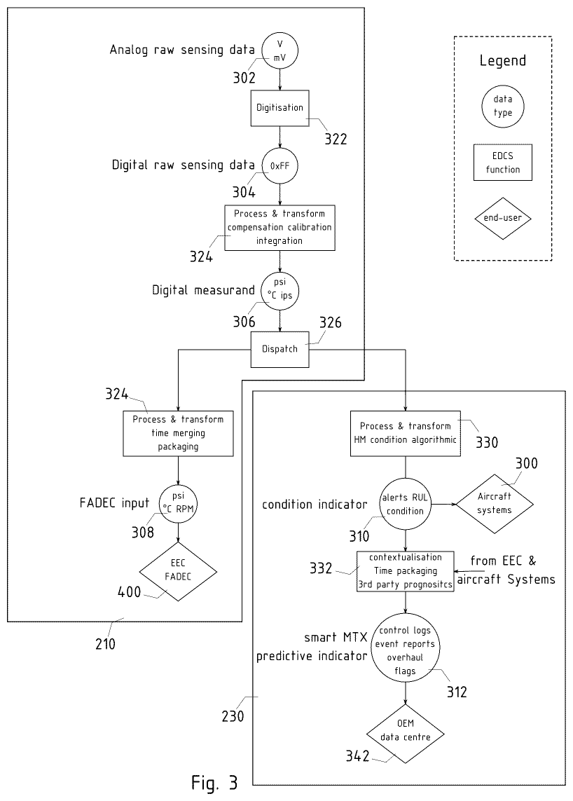

The graph of FIG. 3 details the role of the distributed system of the invention in maximising data value for all end-users in cascading step through a set of embedded functionalities that will be laid out further. In the graph, circle nodes represent data types, rectangular node represent operations or functions of the data concentration system, and diamond-shaped nodes represent data consumers or end-users.

At the top of the graph are the raw analogue data 302 coming from sensor devices in the engine, or in the airframe where appropriate. These are in general voltage levels in a range of some volts or millivolts and are related to the physical quantity that the sensor is designed to measure through a conversion law that is in principle known. Although voltage signals are the most common analog signal, there could be also signal of charge, current, resistance, capacitance, frequency and so on. The raw analogue data are present in very high volumes, but they cannot be used directly by the end-users; hence, their intrinsic value is low.

Node 322 represents the digitalization of the raw data, for example by ADC. The digital data 304 are numeric representation of the analogue data 302 and their value is low, and they exist in high volume.

Function node 324 represents the application of the necessary calibration and compensation that transform the raw data into numerical values 306 of the underlying measurands, for example, psi for pressure, ° C. for temperature, impulsion per second for shaft speed, and so on. The same functional block also includes integration and filtering of the raw data series into filtered series that may show lower noises and repetition rates. The measurand values 306 have medium volume (are more synthetic than the raw data) and medium value.

326 is a dispatch step where the data are dispatched to different processing chains and end user according to the domain where they belong. The segregation of engine control data (domain 210) from health monitoring data (domain 230) is essential for safety and certification. In variants, the health monitoring data 230 could be handled differently, for example treated by a wholly separate system, as in FIG. 1.

Following the left branch of the control domain 210, the measurands may be passed to an additional function of processing and transforming 324, if necessary, where they may be combined according to the respective measure times, and packages in data structures that represent, for example, the instantaneous status of a subsystem or of a group of sensors of special interests. After this last processing we have FADEC input data 308 that are dispatched to the engine controller 400.

In the monitoring domain 230 the data may be also processed further in step 330 by health-monitoring specific conditioning algorithms, and may yield condition indicators 310, for example alert flags, RUL estimation, or other conditions relevant to the to the health monitoring of the engine and/or of the aircraft. These data are then distributed to aircraft systems 344, contextualized with additional information coming from the EEC or aircraft system or processed by prognostic algorithms, possibly provided by third parties, to give smart MTX predictive indicators 312 that are consumed by the OEM data centre 342.

FIG. 2 shows a system with its principal external interfaces, omitting the ground support. As already mentioned, the blocks of FIG. 2 must be interpreted as functional and do not necessarily represent each a single LRU, but rather a network of LRUs as it will be clearer later. Table 2 summarises possible interfaces used in the invention, while table 3 enumerates types of analog sensor used in the same context. These lists are not exhaustive.

TABLE 2
possible interfaces

| interlocutor | Connection type | Interface functions |
|---|---|---|
| Sensors | Analog input | receives sensing data for |
| | (table 3) | conditioning and digitizing |
| EEC/FADEC | Bidirectional | transmits control sensing |
| | digital | data (batch dump or selective |
| | | data based on specific |
| | | requests of the FADEC). |
| | | receives setpoints and parameters |
| | | used for health monitoring |
| Aircraft | Bidirectional | transmits health monitoring |
| systems | digital | levels and alerts |
| | | receives setpoints and parameters |
| | | used |
| Data centre/ | Digital output | transmits via airframe |
| cloud | | contextualised engine |
| | | HM data |
| Ground support | Bidirectional | transmits self-diagnostics |
| | digital, | and selected data receives |
| | may be wireless | configuration files |

TABLE 3
sensor types

| | Output | Sensing | | Smart |
|---|---|---|---|---|
| sensor type | signal | domain | Typical frontend | sensor |
| accelerometer | PE charge | HM | Charge amplifier | no |
| tachometer | voltage | Control | Voltage amplifier | no |
| thermocouple | voltage | Control | Reference junction and | |
| | | | amplifier | |
| RTD | resistance | Control | Current injection and | no |
| | | | voltage amplifier | |
| Pressure | resistance | control | Voltage injection and | no |
| bridge | | | voltage amplifier | |
| Oil level | capacitance | HM | Voltage injection and | no |
| sensor | | | voltage amplifier | |
| Oil quality | Analog/ | HM | Voltage amplifier or | yes |
| | digital | | digital bus | |
| Optical | analog | Control/ | Optical interrogation | yes |
| sensor | | HM | or digital bus | |
| TDR | Analog/ | HM | Voltage amplifier or | yes |
| | digital | | digital bus | |
| LVDT | voltage | control | AC input and voltage | yes |
| | | | demodulator | |
| Mass flow | voltage | Control/ | Voltage amplifier and | no |
| meter | | HM | phase detector | |
| Power | voltage | Control/ | Current sense voltage | yes |
| sensing | | HM | amplifier | |

### Functional Requirements

At a functional level, the functions of the inventive system can be summarised as follows:
1. Acquire engine data: preferably accommodates current and future data input types to perform functions 3.0 and 4.0
   1.1. Digitise data from analog input: may incorporate all front-end circuitry required to condition and digitise analog data coming from the whole engine sensors suite. See table 3
   1.2. Get data from digital input: data received by EEC, FADEC and aircraft systems will transit through a digital bus. Smart sensors may have a digital output and they will need to be acquired accordingly.
2. Manage analog acquisition chain: may include smart sensing functions to complement sensors that use them, see 3.4
   2.1. Provide analog BIT features: preferably the distributed system of the invention holds constantly a status of the health status of its sensor devices and circuitry, especially for the control loop. It includes an initialisation BIT with recognition of fault types as well as a continuous BIT checking the functionality in real time.
   2.2. Incorporate compensation and calibration logic: as part of the smart sensing functionalities, may perform compensation and calibration of sensors that cannot do them themselves. This may include the application of pre-registered response curves, temperature compensation algorithms or BIT-led drift adaptations.
   2.3. Manage measurement synchronisation: preferably ensures the integrity and the time contextualisation of measurements to feed reliable data to the control loop and the contextualization algorithms.
3. Manage data: Importantly, the depth and scope of each data management function varies depending on the data type, sensing domain and timing requirements. The graph of FIG. 3 summarise the data transformation processes.
   3.1. Process & transform: may appear at several steps of the data transformation process. It may use or combine types of input and convert them into a new type of output of increased value.
   3.2. Store: Data may be recorded in volatile storages for live processing or in long time storage for configurations, logs, or buffering of useful data.
   3.3. Contextualise: when a set of valuable HM data has been processed, they may be combined or encapsulated in a transmissible dataset containing a maximum number of data related to a single event (e. g. time periodic reports, alert, condition-based event).
   3.4. Dispatch: functions managing the data dispatching between end-users. As shown in the architecture variants, some acquired control data needs to be both immediately transmitted to the FADEC and relayed to the HM block.
   3.5. Encrypt: Data may need to be encrypted when transiting through the third parties' nodes (e. g. contextualised data sent via SATCOM, transiting to a data centre by airframe systems) to insure IP protection for the end-users.
4. Manage system a control or supervision software (e. g. an OS, API or FSM) may coordinate all system functionalities.
   4.1. Provide system BIT features: start-up and continuous health monitoring of internal circuitry and network modules, including fault detection and identification.
   4.2. Host & interface with third parties' AS: HW may be dedicated, and an API may provide an interface to 3^{rd} parties' AS which would run customer-proprietary data transformation algorithms.
5. Communicate: may implement communication channels with the external interfaces mentioned in section 3.4
   5.1. Internally between modules: the distributed system may be implemented as a network of LRUs. A digital network shall provide a communication link between the modules depending on the selected network.
   5.2. With FADEC/EEC: A bidirectional interface with the FADEC may be provided by legacy protocols such as RS422, which is a good candidate for what reliability and integrity are concerned, or another bus selected in partnership with customers.
   5.3. With aircraft systems: A bidirectional digital interface with the cockpit avionics is advantageous. Among many suitable communication protocols, AFDX is a good candidate for reliability, speed and integrity.
   5.4. With remote data centre: preferably, through a digital SATCOM transmitter via a suitable data interface, for example AFDX. May involve transit of data through airframe data concentrators.
   5.5. With maintenance ground station: a digital link is advantageous to direct and coordinate DCS maintenance activities. Wi-Fi is a possible candidate.
6. Manage power: Preferably, the data concentration system is autonomous in power management.
   6.1. AC/DC conversion: The AC voltage from the engine alternator is rectified to provide a DC voltage.
   6.2. DC/DC conversion: the DC voltage is converted to stable voltages as required by the underlying circuitry, for example 28 VDC, 15 VDC, 12 VDC, 5 VDC, 3.3 VDC
7. Manage environmental constraints: The distributed modules should be capable of withstanding the mechanical thermal and lifetime constraints required from engine-mounted components.
   7.1. Fan case: conditions prevailing in the fan case, relevant for fan-mounted LRUs
   7.2. Core case: conditions prevailing in the core case, relevant for core-mounted LRUs

### Architecture Variants

This section investigates the allocation of functions to a set of LRU defining a HW layout of a possible implementation of the invention as defined above and in the claims. By replacing point-to-point analog data transfer with a digital bus network, significant efficiency in weight data rate & data integrity can be achieved. Different topologies are proposed.

### Semi-Distributed Star Network

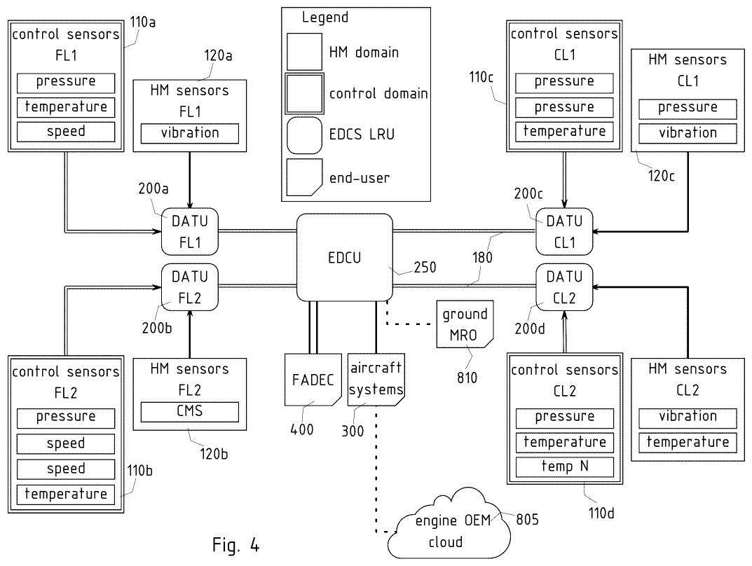

FIG. 4 describes a semi-distributed star network for the invention. This example relates to monitoring and/or controlling a turbofan engine in the propulsion system of an aircraft, but the invention is not limited thereto. The distributed system comprises one data concentration unit (EDCU) 250 that is a replaceable unit (an LRU) located in a suitable position of the engine, for example the fan, and is designed and configured to withstand the environmental conditions that can be expected in this location.

In this example, the EDCU 250 has a bidirectional digital link with a FADEC unit 400. On this link, the EDCU 250 transmits sensor data relevant to engine control and receive from the FADEC 400 setpoints and parameters used for health monitoring. The EDCU 250 has also a bidirectional digital link with other aircraft systems 300, represented as a single end user for simplicity, to transmit HM levels and alerts and receive setpoints and parameters used for health monitoring. The aircraft systems may include a (possibly wireless) link with cloud-located servers 805 of the manufacturer of the engine, or of the plane.

The EDCU 250 has also a digital bidirectional communication link with the ground support infrastructure 810. This link, which may be wireless, is used to upload configuration files to the EDCU and to download self-diagnostic data to the ground support, as well as data selected by the ground support for diagnostics.

A plurality of sensors at various positions on the engine. This example foresees the four locations FL1, FL2, CL1, CL2 of table 1, but other arrangements are possible. Each location hosts sensors dedicated to engine control 110a-d, sensor for health monitoring 120a-d as well as a data acquisition unit 200a-d The data acquisition units receive analog signals generated by the sensors are in the same location and perform smart sensing functionalities for all sensors for all locations. DATU's 200a-d acquire the analog sense signals generated by the respective sensors, digitise it, apply suitable processing (for example calibration, compensation, unit conversion, . . . ) and transmit it to the EDCU 250 over a suitable link 180, for example a SPI-type bus, or another form of digital serial link.

DATUs 120a-d are designed and configured to withstand the environmental conditions expected in the location in which they are destined to operate and, preferably, are placed as close as possible to the sensor that they serve, minimising the length of the cables carrying analog signals. Preferably the DATUs, especially those in the core locations, shall be capable of operating at high temperature, for example above 100° C. or, better, above 120° C. with the EDCU 250 over which they transmit data acquisition units 200a-200d that are configured to acquire analog data from sensors or groups of sensors and transmit them to the EDCU 250.

The DATU preferably receive their power supply from the EDCU 250 that has a role of power master, through a suitable DC power bus, not represented. The power bus may be independent from the data bus 180, requiring its own cabling, or else rely on the same conductors: power and data combined in a common 2-wire cable.

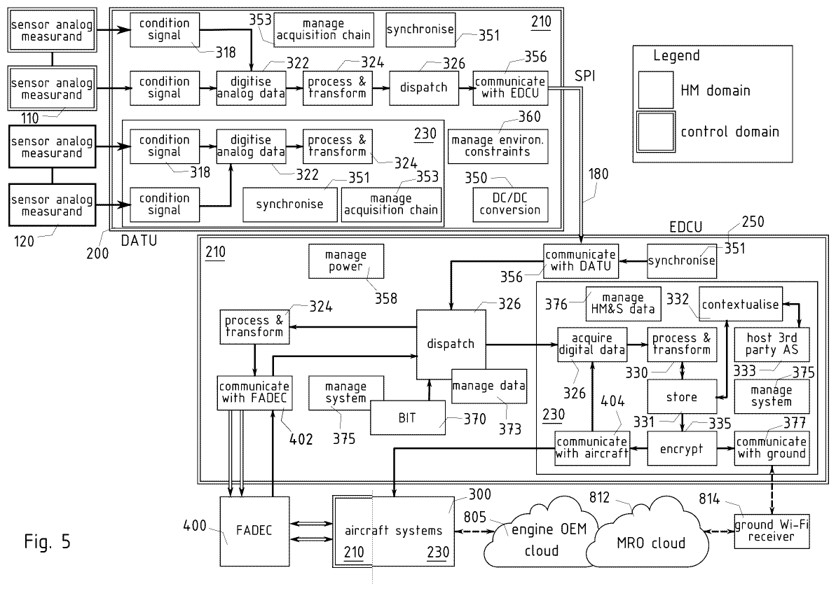

FIG. 5 illustrates the functional allocation in the system. The labels have the meanings defined in the function list above. For simplicity, only one DATU 200 is represented. The DATU 200 reads analog data from control sensors 110 and monitoring sensors 120. The conditioning function may comprise any suitable analog frontend, as required by the nature of the sensor (see table 3). Conversion to digital 322 is carried out by A/D converter. Preferably, one A/D converter could digitise signals from more than one sensor, in multiplexed fashion. Processing and transforming functions 324 may include calibration, application of a known sensor response curve, temperature compensation, integration, digital filtering, and so on. The transformed data are prepared for transmission in step 326 and transferred to a serial interface 356 through which they are sent along the serial link 180 to the EDCU 250.

Preferably, the DATU is equipped with a DC/DC converter 350 that receive a supply voltage available on the DC supply bus and generates all the DC voltages required by the circuitry of the DATU, for example a 3.3 VDC voltage and a 5 VDC voltage for logic circuits, a symmetric ±12 VDC for analog frontends, and so on. The DATUs also implements a synchronisation function 351 where a local clock is synchronised with an external time reference, by any suitable synchronisation protocol, and are configured to manage the acquisition chain (block 353) and to cope with environmental constraints (block 360).

The example shows that each location has a single DATU that processes both data from control sensors 110a-d and data from monitoring sensors 120a-d. Each DATU has, in this example, separate processing blocks for control data monitoring data. Possibly, they could be replaced by a single processing block handling both control data and monitoring data and certifiable for safety-critical operation, for simplicity.

According to the specifics of the implementation, one or both DATUs in the same location where the EDCU 250 is located (typically the fan) may be integrated in the EDCU, rather than provided as separate replaceable units.

FIG. 5 shows, by a functional allocation diagram, how the functional requirements are shared among a DATU 200 and the EDCU 250 for this variant of the invention, among others: a DATU communication function 356 that receives digital sense data from the serial links 180 for processing. Synchronisation 351, as in the DATU, and a dispatch function 326 that determine how the received data should be processed. Engine control data are transmitted to the FADEC 400 through a transformation function 324 and a communication function 402.

Monitoring data (safety-concerned domain) are treated separately and, after a processing 330 they can be stored (331), contextualised (332) processed by 3^{rd} party's software (333), encrypted (335) and transmitted (404) to aircraft systems 300 or with the ground MRO 812, that is here represented as a set of cloud resources rather than a simple end-user. The communication interfaces may be wireless, as specified in table 2 and in the function list.

The EDCU provides also built-in-test capabilities (370) with start-up and continuous monitoring, fault detection and identification in the circuitry of the concentration unit as well as, preferably, of the DATU 200.

The power management function (354) preferably includes the conversion of the AC voltage from the engine generator to a DC voltage that is distributed to the DATUs through the DC bus, as well as the production of all the DC levels that the EDCU's circuitry requires. An alternative to AC input is to receive stabilised DC power from an upstream aircraft or engine power management unit.

### Distributed DCS Network

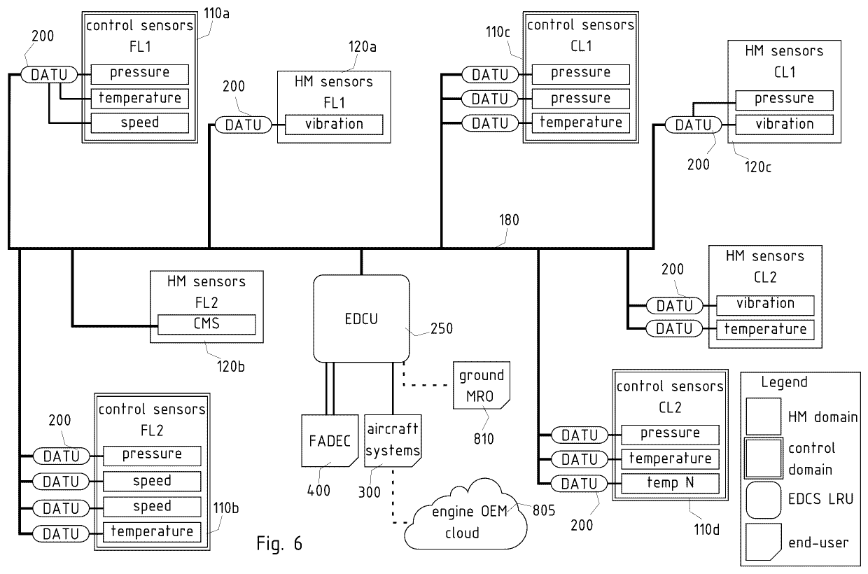

FIG. 6 represents a variant of the invention in which the DATUs are highly miniaturised acquisition units which interface the data network 180 with one sensor or more than one sensor. Preferably, DATUs are configurable LRU, each capable of being configured to accommodate any sensor units with the associated analog front-end out of a plurality of possible sensors. A configurable DATU may be capable of accommodating all the sensors of table 3, or a subset thereof, or more. DATUs are configured to withstand the environmental conditions presents in a specific mounting site, or preferably, both core and fan mounting sites, including high temperature. This allows to plug the DATUS as close as possible to their assigned sensors and perform smart sensing functionality, relaying digitised sensor data to the common bus network 180 for the EDCU 250. As in the previous example, the EDCU 250 fills also the role of power master for all the DATUs. As seen previously, the power bus may be separate and independent from the data bus 180 or combined therewith.

The DCU 250 is split between control and monitoring domains, depending on the end-users of the processed information. All critical functionalities (especially power management and data dispatching) are included in the safety critical control domain. The DCU appears on the network 180 as a node, making the architecture fully distributed. Conceivably, the DCU may also include a DATU interface to read directly sensors in the near proximity, for example in the fan case.

The distributed system of the invention may include also ‘smart’ sensors that provide digitised data directly on the data network 180 without the intermediation of a DATU. Such is the case, for example of OMS sensor 120b.

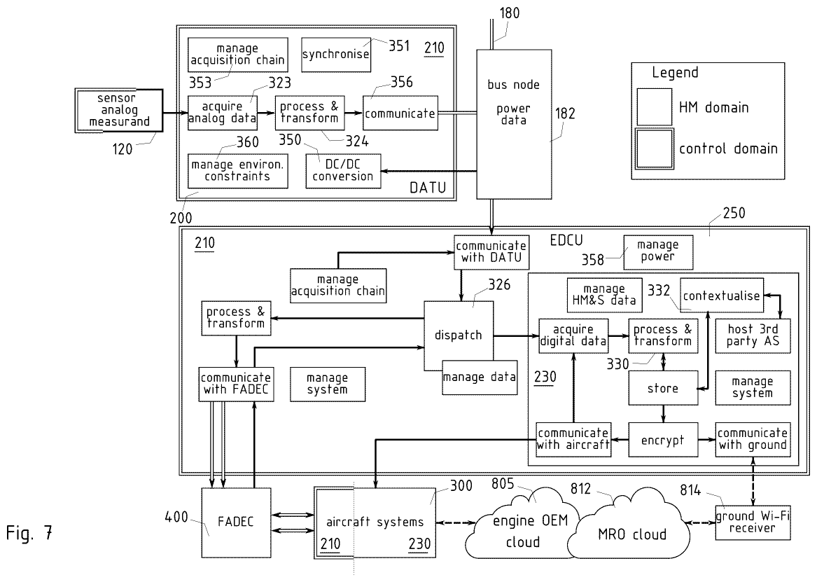

FIG. 7 shows, by a functional allocation diagram, how the functional requirements are shared among a DATU 200 and the EDCU 250 for this variant of the invention. Some functions that are like in the previous example will not be described, for brevity. The DATU is preferably a generalist LRU that can accommodate many sensors 120 and therefore it may be agnostic to whether they are used for control-critical measurements or for health monitoring.

The DATU 200 includes a single control block that acquires the analog data, digitise them, process and transform them suitably, as described in the previous example, and transmits them to the EDCU unit 250. Functionally, the bus node 182 stands for the separation between data interfaces, toward the network 180 and power interfaces, for the DC power generated by the EDCU that acts as a power master.

### Tree Network

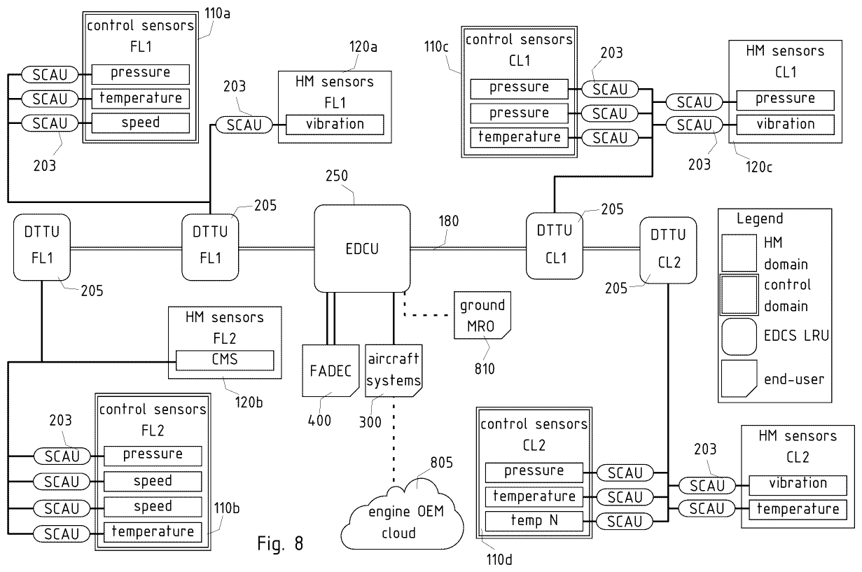

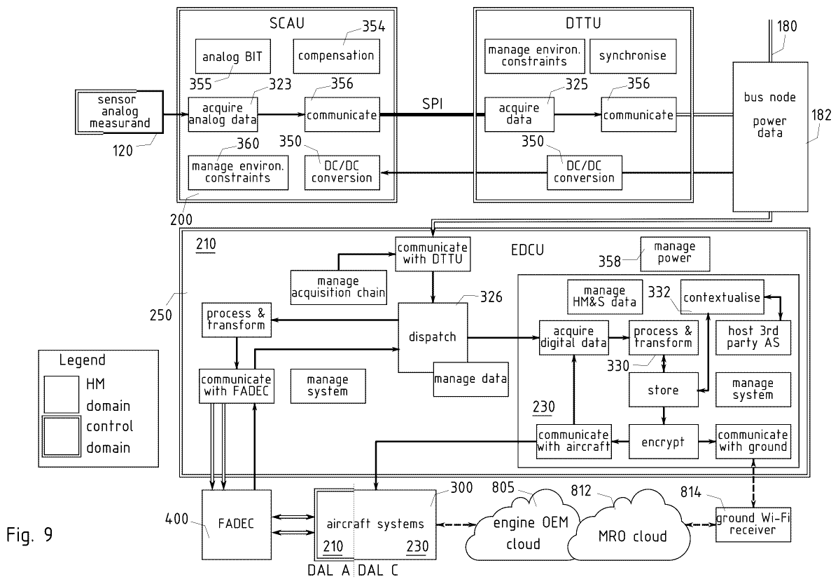

FIGS. 8 and 9 relate to a variant where the acquisition units 203 (SCAU) do not have a network interface suitable for communicating with the EDCU 250 directly. The bus 180 is equipped with data transformation and transmission units 205 (DTTU), each of which receives data from one or more acquisition units 203. The SCAU are each assigned to a unique sensor and, as above, are highly configurable and miniaturised devices that can be placed immediately close to the assigned sensors. They are preferably configurable to accommodate several sensor types and digitise the sensor data at a predefined rate. The number of SCAUs is not defined rigidly but, preferably there is one in each of the installation positions, two for the fan case, two for the core case in this example.

The DTTUs 205 interrogate each of the respective SCAU slaves 203 using a serial link, then transform and combine the data before transmitting them to the EDCU 250 through a data bus or, preferably, a common power and data bus. This architecture allows splitting the data transformation functions between the DTTU and the SCAUs, reducing the complexity of each LRU. SCAUs and DTTUs shall withstand both fan and core environment constraints, including high temperature.

The EDCU unit 250 acts and power and data master and is responsible for advanced processing, power management and dispatching the data to the FADEC, aircraft systems and MRO, as seen previously.

### Hybrid Mesh Topology

In this, non-illustrated, variant, the control domain and the health monitoring domain are physically segregated. Control sensing DATU directly link to the FADEC and health monitoring DATUS link directly to the DCU.

LRUs are placed in a sequential node-based system where data flows from the furthest LRUs and are consolidated within the closest LRU before being transmitted to the end-user.

### Opto-Electronic DCS Network

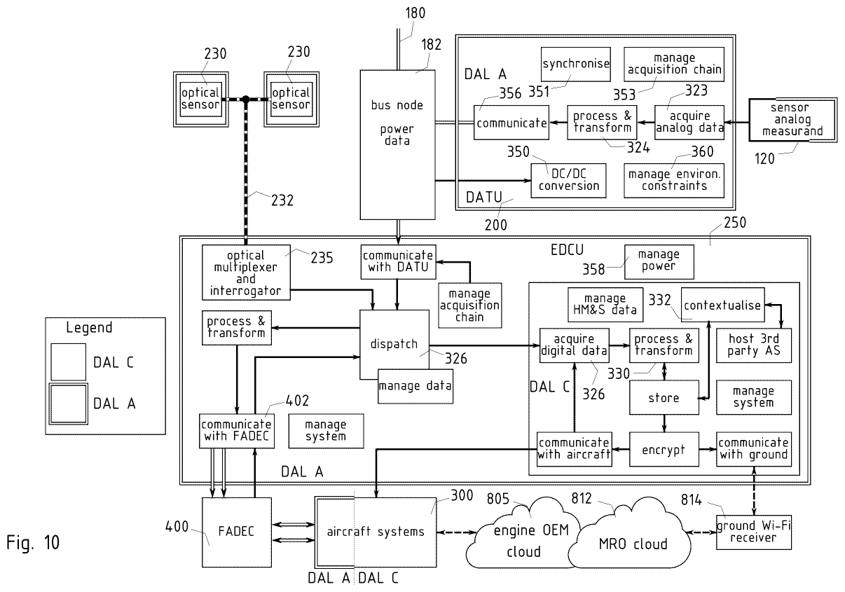

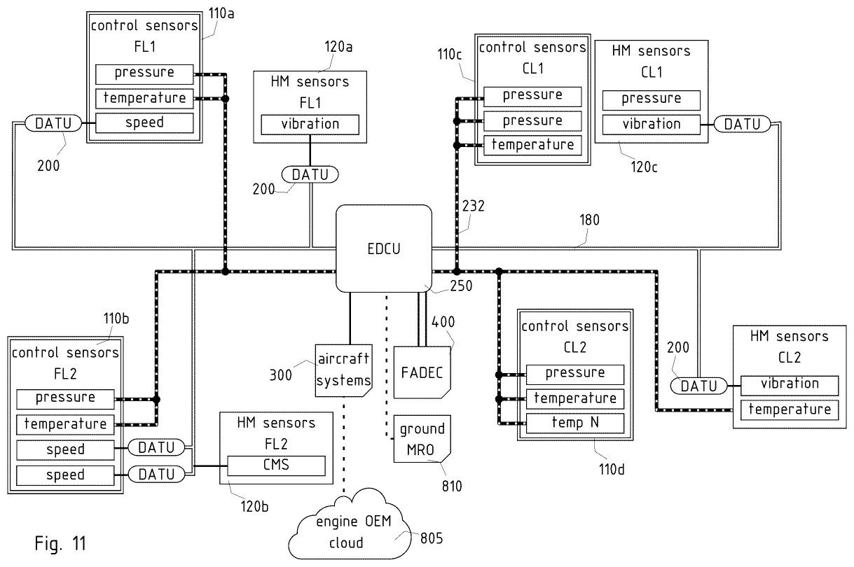

FIGS. 10 and 11 relate to a variant of the invention that includes optical sensors. Electric sensors are read through DATUs 200 and a network 180 as laid out in the previous examples. The topology of FIG. 11 for the electric sensor is that of the distributed network of FIG. 6, but this is not an obligated choice, and any of the network disclosed above could be adopted. The EDCU comprise an optical interrogation unit and address all optical sensors through multiplexing or sequential interrogation, providing a dedicated centralized implementation of the acquisition and management of analog data for all the concerned measurands.

As seen previously, the EDCU 250 serves as power and data master for all the DATUs 200, through a data bus and a DC power bus, which may be combined in a single bus, where the power is distributed over the same conductors as the data. The DCU 250 again takes care of power management, advanced processing and dispatches to the concerned end users, having regard to the separation between control and monitoring safety domains.

### Synchronisation

In a multi-sensor environment, it is often required to correlate data gathered by different sensor. An example often encountered in gas turbines is the tracking of rotating shafts. This is achieved by precise correlation of speed and vibration data. When the data coming from the sensors are acquired by the same electronic unit such that the digital samples can be located in time with respect to a common electronic clock, the correlation can be very precise. Not so when the data come from different units in a distributed system, each having an independent clock.

In a variant of the invention, the concerned nodes in the distributed sensor (for example DATUs, SCAUs or DTTUs acquiring the sensor data that should be correlated, as well as the DCU) maintain a real-time clock. This may be a low-burden clock based on a hardware timer in a microcontroller or in a CPU. The resolution of the RTC is linked to the rate of the system clock. In an exemplary implementation, the RTC may involve two 32-bit counters, a second counter and a nano-second counter. The nano-second counter is updated by a hardware timer and stores the fractional value of time in seconds with a resolution, for example, of 6.66667 ns. The second counter is updated by a software interrupt every second. To simplify the timekeeping and reduce the size of the timestamp, a cyclic or repeating timeframe may be used across the whole system. The timeframe repeats after a stated, configurable interval, in seconds.

RTC from different nodes are kept in synch by a suitable synchronisation protocol over the data network 180, to which all the concerned nodes belong. PTP is a possible solution, and implementations of PTP over CAN exist, but it is not the only one. The synchronisation may use specific properties of the CAN protocol, CAN bus timers from transmit and receive mailboxes, as well as CAN network properties such as signal delay on bus itself.

The frequency of RTC sync is variable and is based on clock drift rate between nodes, acquisition sampling frequency and accuracy requirements on for a specific measurement. The rate of clock drift is calculated and updated at every synchronisation, which drives the synchronisation parameters.

A remarkable use case of node synchronisation is the tracked order processing of speed and vibration of a turbine shaft. The speed data are read by a first node, for example a DATU collecting data from a tachometer. The first node broadcasts interpolated accurate timestamps of zero-crossing on the network. Each of these is a precise estimate of the instant at which the rotation phase of the shaft reaches a predetermined value, conventionally chosen as zero. Vibration data are read by an accelerometer and are digitised by a second network node (DATU, SCAU, DTTU, . . . ). Both first and second node have a RTC that is synchronised, such that the timestamps and the times of the vibration data are comparable.

The zero-crossing timestamps are maintained by the second node in a two-way memory buffer that allows simultaneous read and write to determine speed and zero-crossing references. The accelerometer node uses them along with its own time-reference accelerometer data to perform the tracked order processing.

The frequency of zero-crossing messages is preferably determined automatically to optimize the network load while optimising the requirements of the tracking filter.

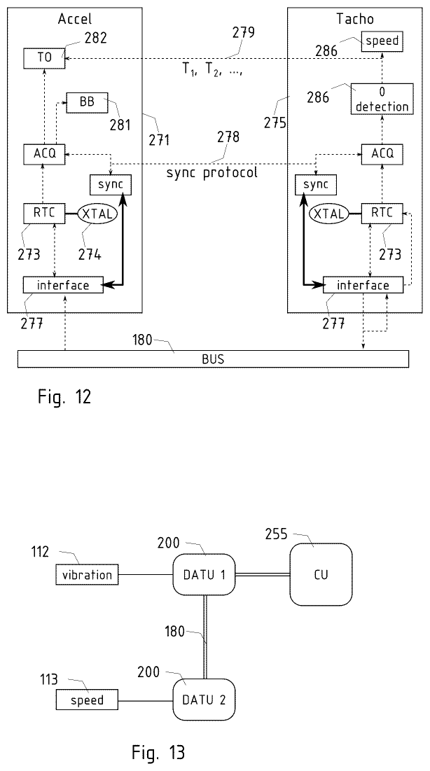

FIG. 12 shows the tracked order use case schematically. The process involves two network nodes, a first node 275, for example a DATU, that acquires sensor data from a tachometer, and a second node 271, which could be another DATU, receiving sensor data from an accelerometer. Each of them has a RTC 273 driven by a local crystal oscillator 274 and synchronised by a suitable network synchronisation protocol 278.

The first node 275 computes a speed value for the shaft. This may be a primary function of this node, and the speed value may be transmitted to any suitable end-user, for example to a FADEC or to airplane systems, for control or monitoring purposes, as disclosed above. At the same time the first node determines the instant of zero-crossing of the phase, according to its synchronised RTC, and transmits them on the network, where the second node 271 can read and store them in a buffer as explained.

The second node 271 that has a similar synchronised RTC acquires vibration data from an accelerometer sensor, processes them (281) and performs the required track order analysis using the zero-crossing timestamps 279.

To better perform these multiple tasks, the nodes of the distributed system, are preferably configurable to carry out multiple processing job. A processing job is a container for data and code that defines an input-process-output sequence. Each node may have multiple processing jobs defined.

Each processing job keeps track of resource utilization, including use of CPU and memory, thus providing static and dynamic analysis of CPU and memory bandwidth on each node. Processing jobs can refer to other similar processing job across the EDCS, such that a job may consume an output of another processing job executed in the same node or in another one.

### Distributed Vibration Monitoring

As seen in the previous example, speed and vibration data are usually handled through two different nodes. While vibration data are generally used for monitoring purposes, speed data is essential to engine control. A failure in the speed node could thus lead to a very serious safety event. To mitigate this effect, there is a possibility to extract coarse speed and tracking information directly from the vibration node through a spectral analysis of the broadband vibration, for example by determining a fundamental frequency of the vibration. This information can be used in a degraded mode to overcome a temporary loss of the speed node functionality.

FIG. 13 refers to this use case and shows a—very simplified—distributed system including two DATUS 200, one reading a vibration sensor and another reading a speed sensor, on a distributed bus 180 that has also a control unit 255.

According to this variant of the invention, the availability of data in different failure conditions is given by table 4.

### Availability Classes

NO normal operation
NCD no computed data
degraded degraded functionality
FW failure warning

TABLE 4

| | | Broadband | Tracked |
|---|---|---|---|
| Failure mode | Engine speed | vibration | order |
| nominal | NO | NO | NO |
| loss of accelerometer input | NO | NCD | NCD |
| loss of DATU 1 | NO | NCD | NCD |
| loss of tachometer input | degraded | NO | degraded |
| loss of DATU 2 | degraded | NO | degraded |

In case of loss of the tachometer cable or of the corresponding DATU 2, the DATU 1 node will provide a degraded value of speed from the spectral analysis of the vibration data. The tracked order vibration is available in degraded form, without the phase information.

In contrast, a system with centralised processing would be unable to provide any speed information or tracked order analysis in case of loss of the DATU 2 or of its cable.

TABLE 5

| | | Broadband | Tracked |
|---|---|---|---|
| Failure mode | Engine speed | vibration | order |
| nominal | NO | NO | NO |
| loss of accelerometer cable | NO | NCD | NCD |
| loss of DATU 1 | NO | NCD | NCD |
| loss of tachometer cable | NCD | NO | NCD |
| loss of DATU 2 | NCD | NO | NCD |

### REFERENCE SYMBOLS IN THE FIGURES

104 engine sensors
110 sensor analog measurand: control domain
110a sensor analog measurand: control domain; fan location 1
110b sensor analog measurand: control domain; fan location 2
110c sensor analog measurand: control domain; core location 1
110d sensor analog measurand: control domain; core location 2
112 vibration sensor, accelerometer
113 speed sensor, tachometer
114 engine sensors
116 engine actuators
120 sensor analog measurand: monitoring domain
120a sensor analog measurand: monitoring domain; fan location 1
120b sensor analog measurand: monitoring domain; fan location 2
120c sensor analog measurand: monitoring domain; core location 1
120d sensor analog measurand: monitoring domain; core location 2
134 engine sensors
180 digital data network
182 bus node, power extraction
200 DATU
200a DATU, fan location 1
200b DATU, fan location 2
200c DATU, core location 1
200d DATU, core location 2
203 SCAU
205 DTTU
210 engine control domain
230 health monitoring domain
232 optical data transmission, optical fibre
235 optical multiplexer and interrogator
250 EDCU
271 first node
273 RTC
274 crystal resonator
275 second node
277 bus interface
278 synchronisation protocol
279 zero crossing timestamps
281 align
282 tracked order analysis
286 speed data
300 aircraft systems
302 analog raw sensing data
304 digital raw sensing data
306 digital measurand
308 FADEC input data
310 condition indicator
312 smart MTX prediction indicator
318 condition signal
322 digitisation
323 data acquisition, analog data
324 process and transform, time merging, packaging, control data
325 data acquisition, digital data
326 dispatch
330 process and transform, HM condition algorithmic
331 store
332 contextualisation, time packaging, 3^{rd} party's prognostics
333 host 3^{rd} party's application software
335 encrypt
342 OEM data centre
350 DC/DC conversion
351 synchronise
353 manage acquisition chain
354 compensation
355 analog BIT
356 communicate, communicate with EDCU/DATU
358 manage power
360 manage environmental constraints
370 BIT
373 manage data
375 manage system
376 manage HM and safety data
377 communicate with ground
400 FADEC/EEC
402 communicate with FADEC
500 EMU
503 digital FADEC/Aircraft systems interface
504 transmission EMU/FADEC
550 DCS, data concentration system
800 ground MTX data centre
805 engine OEM cloud
810 ground MRO
812 MRO cloud
814 ground Wi-Fi receiver

1. A distributed system for monitoring an aircraft or a gas turbine engine for an aircraft, comprising:
a plurality of sense devices positioned at different locations on the aircraft or on the gas turbine engine, each sense device being configured to react to a value of a physical parameter of the aircraft or of the gas turbine engine and deliver an analog signal representing said physical parameter;
data acquisition units configured to receive analog signals from at least one of the plurality of sense devices and convert it to digital sensor data and a digital network to which the data acquisition units have access, wherein at least one data concentration unit is configured to receive digital sensor data from more than one of the data acquisition units, and wherein the at least one data concentration unit is either part of the data acquisition units or a separate unit with a network interface connected to the digital network.

2. The distributed system of claim 1, wherein the data concentration unit is configured to dispatch digital sensor data to an engine control processing chain or to a health monitoring processing chain, the engine control processing chain and health monitoring processing chain being segregated from one another.

3. The distributed system of claim 2, wherein the engine control processing chain produces engine control data that are made available to an electronic engine control unit.

4. The distributed system of any one of claim 2 or 3, wherein the health monitoring processing chain is configured to encrypt monitoring data and transmit them through a communication interface of the data concentration unit to a ground-based MRO.

5. The distributed system of claim 1, wherein the digital network comprises a plurality of serial point-to-point links, each linking at least one of the data acquisition units to the data concentration unit, the data concentration unit having a role of master.

6. The distributed system of claim 1, further comprising:
an electronic engine controller with a network interface connected to the digital network.

7. The distributed system of claim 1, wherein the sense devices comprise one or more sense devices selected from the group consisting of temperature sensors, pressure sensors, tachometers, vibration sensors, linear or angular displacement sensor, accelerometers, fluid level sensors and airspeed sensors.

8. The distributed system of any claim 1, wherein at least one of the data acquisition units includes a multichannel ADC receiving analog signals from a plurality of the sense devices and converts it to digital sensor data.

9. The distributed system of claim 1, wherein the data acquisition units receive a power supply from a DC bus.

10. The distributed system of claim 1, wherein one or more of the data acquisition units has an optical data interface configured to receive an optical signal from an optical sensor and generate digital sensor data based on the optical signal.

11. The distributed system of claim 1, wherein a first data acquisition unit of the data acquisition units is connected to a tachometer sensor configured to generate a speed value representing a rotation speed of a shaft and the first data acquisition unit being configured to make the speed value available on the network, and wherein a second data acquisition unit of the data acquisition units is connected to a vibration sensor generating a vibration signal representing a dynamic vibration generated by the shaft, and wherein the second data acquisition unit is configured to compute an auxiliary speed value based on the vibration signal and to make the auxiliary speed value available on the network.

12. The distributed system of claim 1, wherein a first data acquisition unit and a second data acquisition unit of the data acquisition units maintain a first clock and a second clock respectively, the first data acquisition unit being configured to synchronise the first clock to the second clock of the second data acquisition unit.

13. The distributed system of claim 1, wherein a first data acquisition unit of the data acquisition units is connected to a tachometer sensor, configured to generate a rotation signal comprising a series of time values representing an instant in time at which a rotating shaft completes a revolution, and a second data acquisition unit of the data acquisition units is connected to a vibration sensor, generating a vibration signal representing a dynamic vibration generated by the rotating shaft, the distributed system comprising a computing resource having access to the rotation signal and to the vibration signal and configured to correlate the vibration signal with the rotation signal.

14. A method of monitoring an aircraft or a gas turbine engine comprising:
positioning a plurality of sense devices at different locations on the aircraft or on the gas turbine engine,
positioning on the aircraft or gas turbine engine data acquisition units;
transmitting an analog signal representing a physical parameter of the aircraft or of the gas turbine engine from a selected sense device of the plurality of sense devices;
receiving the analog signal from the selected sense device at a data acquisition unit of the data acquisition units;
converting the analog signal to digital sensor data in the data acquisition unit that receives the analog signal, and
transmitting the digital sensor data from the data acquisition unit on a digital network;
transmitting the digital sensor data by more than one data acquisition unit to a data concentration unit, wherein the data concentration unit is either part of a data acquisition unit or a separate node in the digital network;
and wherein the data concentration unit is configured to dispatch digital sensor data to an engine control processing chain or to a health monitoring processing chain, the engine control processing chain and health monitoring processing chain being segregated from one another.

15. The method of claim 14, wherein the data acquisition units constitute a distributed monitoring system on the digital network.

16. The method of claim 14, further comprising:
receiving in one of the data acquisition units of the data acquisition units an analog vibration signal representing a vibration of a shaft;
computing an auxiliary speed value based on the vibration signal; and
making the auxiliary speed value available on the digital network.

17. The method of claim 14, further comprising:
synchronising a first clock of a first data acquisition unit in the data acquisition units with a second clock of a second data acquisition unit in the data acquisition units.

18. The method of claim 17, further comprising:
receiving in the first data acquisition unit an analog rotation signal from a tachometer sensor comprising a series of time values representing instants in time at which a rotating shaft completes a revolution;
receiving in the second data acquisition unit an analog vibration signal;
generating a set of digital rotation data in the first data acquisition unit and a set of digital vibration data in the second acquisition unit; and
correlating the digital vibration data with the digital rotation data in a digital processing resource on the digital network.
